(19) United States
(12) Patent Application Publication
(10) Pub. No.: US 2023/0341509 A1
(43) Pub. Date: Oct. 26, 2023

(54) SYSTEMS AND METHODS FOR TIME STAMPING OF WI-FI SENSING DATA

(71) Applicant: Cognitive Systems Corp., Waterloo (CA)

(72) Inventors: Chris BEG, Waterloo (CA); Mohammad OMER, Waterloo (CA)

(21) Appl. No.: 17/696,224

(22) Filed: Mar. 16, 2022

Related U.S. Application Data
(60) Provisional application No. 63/162,270, filed on Mar. 17, 2021.

(51) Int. Cl. G01S 7/00; G01S 13/00; G01S 13/56

(52) U.S. Cl. CPC G01S 7/006; G01S 13/003; G01S 13/56; H04W 84/12

(57) ABSTRACT

Systems and methods for time stamping of Wi-Fi sensing data are provided. A system may include a sensing device. The sensing device may be configured to transmit a sensing trigger message to a remote device. The sensing device may also be configured to receive a sensing transmission from the remote devices transmitted in response to the sensing trigger message. The sensing device may further be configured to identify a timing indication in the sensing transmission and generate a time stamp indicating when the sensing transmission was valid from the timing indication. The sensing device may associate the time stamp with the sensing transmission.

### RELATED APPLICATIONS

This application claims the benefit of prior U.S. Provisional Patent Application Ser. No. 63/162,270, filed Mar. 17, 2021, which is hereby incorporated by reference in its entirety for all purposes.

### TECHNICAL FIELD

The present disclosure generally relates to systems and methods for Wi-Fi sensing. In particular, the present disclosure describes systems and methods to perform time stamping of Wi-Fi sensing data.

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems.

A Wi-Fi sensing system is one recent addition to motion detection systems. The Wi-Fi sensing system may include a sensing device and a remote device. In an example, the sensing device may initiate a Wireless Local Area Network (WLAN) sensing session and the remote device may participate in the WLAN session initiated by the sensing device. The WLAN sensing session may refer to a period during which objects in a physical space may be probed, detected and/or characterized. In an example, during the WLAN sensing session, the sensing device and the remote device may contribute to the generation of sensing measurement(s).

### BRIEF SUMMARY OF THE DISCLOSURE

The present disclosure generally relates to systems and methods for Wi-Fi sensing. In particular, the present disclosure relates to systems and methods to perform time stamping of Wi-Fi sensing data.

Systems and methods are provided for time stamping of Wi-Fi sensing data. In an example embodiment, a system is described. The system may include a sensing device. The sensing device may include a transmitting antenna, a receiving antenna, and a processor. The processor may be configured to cause the transmitting antenna to transmit a sensing trigger message. The processor may also be configured to receive, via the receiving antenna, a sensing transmission transmitted in response to the sensing trigger message. The processor may also be configured to identify a timing indication in the sensing transmission, generate a time stamp indicating when the sensing transmission was valid from the timing indication, and associate the time stamp with the sensing transmission.

In some implementations, the processor may be further configured to perform a sensing measurement on the sensing transmission and associate the time stamp with the sensing measurement.

In some implementations, the sensing measurement is performed using a training field of the sensing transmission.

In some implementations, prior to the sensing device receiving the sensing transmission, the sensing device may receive a sensing response announcement.

In some implementations, the processor may be configured to transmit the sensing measurement and the time stamp associated with the sensing measurement to a remote processing device.

In some implementations, the processor may be configured to generate the time stamp by applying a propagation correction to a time determined according to the timing indication.

In some implementations, the propagation correction is indicative of a propagation time through a receive chain of the sensing device.

In some implementations, the processor may be configured to apply the propagation correction such that the time stamp represents a reception time at which the timing indication of the sensing transmission used to perform a sensing measurement is received at a reference point of the sensing device.

In some implementations, the processor may be configured to apply an offset to a time determined according to the timing indication to generate the time stamp.

In some implementations, the system may further include an external time reference source. The external time reference source may be configured to provide a synchronized reference time signal to the sensing device.

In some implementations, the sensing device may further be configured to process the synchronized reference time signal to generate one or more Timing Advertisement (TA) messages in accordance with a reference time included in the synchronized reference time signal.

In another example embodiment, a method for Wi-Fi sensing carried out by a sensing device including a transmitting antenna, a receiving antenna, and a processor is described. The method includes transmitting, via the transmitting antenna, a sensing trigger message, receiving, via the receiving antenna, a sensing transmission transmitted in response to the sensing trigger message, identifying, by the processor, a timing indication in the sensing transmission, generating, by the processor, a time stamp indicating when the sensing transmission was valid from the timing indication, and associating, by the processor, the time stamp with the sensing transmission.

In yet another embodiment, a system is described. The system may include a remote processing device including a transmitting antenna, a receiving antenna, and a processor. The processor may be configured to receive, via the at receiving antenna, a first sensing measurement and a first time stamp associated with the first sensing measurement from a first sensing device, receive, via the receiving antenna, a second sensing measurement and a second time stamp associated with the second sensing measurement from a second sensing device, execute a sensing algorithm according to the first sensing measurement, the first time stamp, the second sensing measurement, and the second time stamp to generate a sensing result.

In some implementations, the processor may be configured to transmit, via the transmitting antenna, the sensing result to a third sensing device.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with a motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts an implementation of some of an architecture of a system for time stamping of Wi-Fi sensing data, according to some embodiments;

FIG. 6 depicts a sequence diagram for application of propagation correction on a sensing response message, according to some embodiments;

FIG. 7 depicts a sequence diagram for application of propagation correction on a sensing response NDP, according to some embodiments;

FIG. 8 depicts a flowchart for generating a time stamp for a sensing transmission, according to some embodiments;

FIG. 9A and FIG. 9B a depict flowchart for generating a time stamp for a sensing transmission to be transmitted to a remote processing device, according to some embodiments; and

FIG. 10 depicts a flowchart for executing a sensing algorithm to generate a sensing result, according to some embodiments.

### DETAILED DESCRIPTION

A Wi-Fi sensing system may measure an environment by transmitting signal(s) to remote device(s) and analyzing response(s) received from the remote device(s). The Wi-Fi sensing system may perform repeated measurements to analyze the environment and the changes thereof. The Wi-Fi sensing system may operate in conjunction with existing communication components, and benefits from having a Medium Access Control (MAC) layer entity, which may be used for the coordination of air-time resource usage among multiple devices based upon defined protocol.

In a highly utilized network where there are many transmissions, it may be difficult for the remote device to ensure that a deterministic and periodic sequence of sensing transmissions can be made alongside its other scheduling commitments. The impact of any scheduling variation may appear as a measurement time jitter. In some scenarios, the measurement time jitter may result in an error in sensing measurement(s).

One of the relevant goals of the Wi-Fi sensing systems is to reduce additional overheads on existing Wi-Fi network, such that overlaying Wi-Fi sensing capability on the 802.11 network does not compromise the communication function of the network. Currently there are no known MAC protocols specifically defined for sensing in the Wi-Fi sensing systems. One aspect of sensing in the Wi-Fi sensing systems is a solicitation of a sensing transmission from a remote device. Improvements to MAC layer to enable solicitation of a sensing transmission from the remote device with characteristics that are optimized to allow the Wi-Fi sensing agent to detect presence, location and motion may significantly impact existing system performance. In particular, the request or solicitation of the remote device transmission optimized for sensing (or a sensing transmission) may impact an uplink scheduler of the remote device. There are existing mechanisms to request or solicit the remote device to transmit the sensing transmission. However, such mechanisms were designed for different purposes. As a result, these mechanisms are not efficient, offer no flexibility in control, and are not universally consistent among different vendor implementations. Furthermore, a channel sounding protocol may be considered for supporting Wi-Fi sensing. However, the channel sounding protocol is not currently flexible and thus, such functionality in support of Wi-Fi sensing is not possible.

Protocols for Wi-Fi systems are designed with decisions made on a basis of the data transfer mechanism as against sensing requirements. As a result, Wi-Fi sensing aspects are frequently not developed within common Wi-Fi systems. With respect to antenna beamforming in the Wi-Fi systems, digital signal processing directs a beam of high antenna gain in the direction of a transmitter or receiver for optimal data transfer purposes and as a result, the antenna pattern may not support or enhance sensing requirements.

In some aspects of what is described herein, a wireless sensing system may be used for a variety of wireless sensing applications by processing wireless signals (e.g., radio frequency signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access-point (AP) assumes the receiver role, and each Wi-Fi device (station or node or peer) connected to the AP assume the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a remote device communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered less frequently. In some implementations, when motion is present, for example, the wireless sensing system can increase the triggering rate to produce a time-series of measurements with finer time resolution. Controlling the variable measurement rate can allow energy conservation (through the device triggering), reduce processing (less data to correlate or filter), and improve resolution during specified times.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

As disclosed in embodiments herein, a wireless local area network (WLAN) sensing procedure allows a station (STA) to perform WLAN sensing. WLAN sensing may include a WLAN sensing session. In examples, WLAN sensing procedure, WLAN sensing, and WLAN sensing session may be referred to as wireless sensing procedure, wireless sensing, and wireless sensing session, Wi-Fi sensing procedure, Wi-Fi sensing, and Wi-Fi sensing session, or sensing procedure, sensing, and sensing session.

WLAN sensing is a service that enables a STA to obtain sensing measurements of the channel(s) between two or more STAs and/or the channel between a receive antenna and a transmit antenna of a STA or an access point (AP). A WLAN sensing procedure may be composed of one or more of the following: sensing session setup, sensing measurement setup, sensing measurement instances, sensing measurement setup termination, and sensing session termination.

In examples disclosed herein, sensing session setup and sensing measurement setup may be referred to as sensing configuration and may be achieved by a sensing configuration message and may be confirmed by a sensing configuration response message. A sensing measurement instance may be an individual sensing measurement and may be derived from a sensing transmission. In examples, the sensing configuration message may be referred to as a sensing measurement setup request, and the sensing configuration response message may be referred to as a sensing measurement setup response.

A WLAN sensing procedure may include multiple sensing measurement instances. In examples, the multiple sensing measurement instances may be referred to a measurement campaign.

A sensing initiator may refer to a STA or an AP that initiates a WLAN sensing procedure. A sensing responder may refer to a STA or an AP that participates in a WLAN sensing procedure initiated by a sensing initiator. A sensing transmitter may refer to a STA or an AP that transmits physical-layer protocol data units (PPDU) used for sensing measurements in a WLAN sensing procedure. A sensing receiver may refer to a STA or an AP that receives PPDUs sent by a sensing transmitter and performs sensing measurements in a WLAN sensing procedure.

In examples, PPDU(s) used for a sensing measurement may be referred to as a sensing transmission.

A STA acting as a sensing initiator may participate in a sensing measurement instance as a sensing transmitter, a sensing receiver, both a sensing transmitter and sensing receiver, or neither a sensing transmitter nor a sensing receiver. A STA acting as a sensing responder may participate in a sensing measurement instance as a sensing transmitter, a sensing receiver, and both a sensing transmitter and a sensing receiver.

In an example, a sensing initiator may be considered to control the WLAN sensing procedure or the measurement campaign.

In examples, a sensing transmitter may be referred to as a remote device and a sensing receiver may be referred to as a sensing device. In other examples, a sensing initiator may be a function of a sensing device or of a remote device, and a sensing responder may be a function of a sensing device or of a remote device.

IEEE P802.11-REVmd/D5.0 considers a STA to be a physical (PHY) and media access controller (MAC) entity capable of supporting features defined by the specification. A device containing a STA may be referred to as a Wi-Fi device. A Wi-Fi device which manages a basic service set (BSS) (as defined by IEEE P802.11-REVmd/D5.0) may be referred to as an AP STA. A Wi-Fi device which is a client node in a BSS may be referred to as a non-AP STA. In some examples, an AP STA may be referred to as an AP and a non-AP STA may be referred to as a STA.

In various embodiments of the disclosure, non-limiting definitions of one or more terms that will be used in the document are provided below.

A term “measurement campaign” may refer to a bi-directional series of sensing transmissions between a sensing device (commonly known as wireless access-point, Wi-Fi access point, access point, sensing initiator, or sensing receiver) and a remote device (commonly known as Wi-Fi device, sensing responder, or sensing transmitter) that allows a series of sensing measurements to be computed.

A term “message” may refer to any set of data which is transferred from the sensing device to the remote device (or vice versa). The message may be carried in a frame and that frame can be a Medium Access Control (MAC)-layer Protocol Data Unit (MPDU) or an Aggregated MPDU (A-MPDU). The frame in the form of an MPDU or A-MPDU may be transferred from the sensing device to the remote device (or vice versa) as a sensing transmission. In an example, the transmission may be carried out by Physical (PHY) layer and may be in the form of a PHY-layer Protocol Data Unit (PPDU).

A term “Null Data PPDU (NDP)” may refer to a PPDU that may not include any data field. In an example, the NDP may be used for a sensing transmission where it is a MAC header that includes required information.

A term “sensing transmission” may refer to any transmission made from the remote device to the sensing device which may be used to make a sensing measurement. In an example, sensing transmission may also be referred to as wireless sensing signal or wireless signal. In an example, the sensing transmission may be either a sensing response message or a sensing response NDP including one or more training fields used to make a sensing measurement.

A term “sensing measurement” may refer to a measurement of a state of a channel i.e., CSI measurement between the remote device and the sensing device derived from a sensing transmission. In an example, sensing measurement may also be referred to as channel response measurement.

A term “Channel State Information (CSI)” may refer to properties of a communications channel that are known or measured by a technique of channel estimation.

A term “transmission parameters” may refer to a set of IEEE 802.11 PHY transmitter configuration parameters which are defined as part of Transmission Vector (TXVECTOR) corresponding to a specific PHY and which are configurable for each PHY-layer protocol data unit (PPDU) transmission.

A term “sensing trigger message” may refer to a message sent from the sensing device to the remote device to trigger one or more sensing transmissions that may be used for performing sensing measurements.

A term “sensing response message” may refer to a message which is included within a sensing transmission from the remote device to the sensing device. The sensing transmission that includes the sensing response message may be used by the sensing device to perform a sensing measurement.

A term “sensing response announcement” may refer to a message that is included within a sensing transmission from the remote device to the sensing device that announces that a sensing response NDP will follow within a short interframe space (SIFS). The sensing response NDP may be transmitted using a requested transmission configuration.

A term “short interframe space (SIFS)” may refer to a period within which a processing element (for example, a microprocessor, dedicated hardware, or any such element) within a device of a Wi-Fi sensing system is able to process data presented to it in a frame. In an example, the short interframe space may be 10 μs.

A term “sensing response NDP” may refer to a response transmitted by the remote device and used for sensing measurement at the sensing device. In an example, the sensing response NDP may be used when a requested transmission configuration is incompatible with transmission parameters required for successful non-sensing message reception. Further, in an example, the sensing response NDP may be announced by the sensing response announcement.

A term “training field” may refer to a sequence of bits transmitted by the remote device which is known by the sensing device and used on reception to measure channel for purposes other than demodulation of data portion of a containing PPDU. In an example, the training field is included within a preamble of a transmitted PPDU. In some examples, a future training field may be defined within a preamble structure (cascading training fields with legacy support) or it may replace existing training fields (non-legacy support).

A term “Timing Synchronization Function (TSF)” may refer to a common timing reference within a set of associated stations providing a Basic Service Set (BSS). In an example, the TSF may be kept synchronized by a beacon message transmitted from a shared access point of the BSS. In an example, the timing resolution of TSF may be 1 microsecond.

A term “time stamp” may refer to an indication of time which may be applied to a sensing transmission or a sensing measurement.

A term “measurement time jitter” may refer to an inaccuracy which is introduced either when a time of measurement of a sensing measurement is inaccurate or when there is no time of measurement available. In examples, measurement time jitter may be referred to as measurement time uncertainty.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes embodiments of systems and methods for Wi-Fi sensing. In particular, section B describes systems and methods to perform time stamping of Wi-Fi sensing data.

### A. Wireless Communications System, Wireless Transmissions, and Sensing Measurements

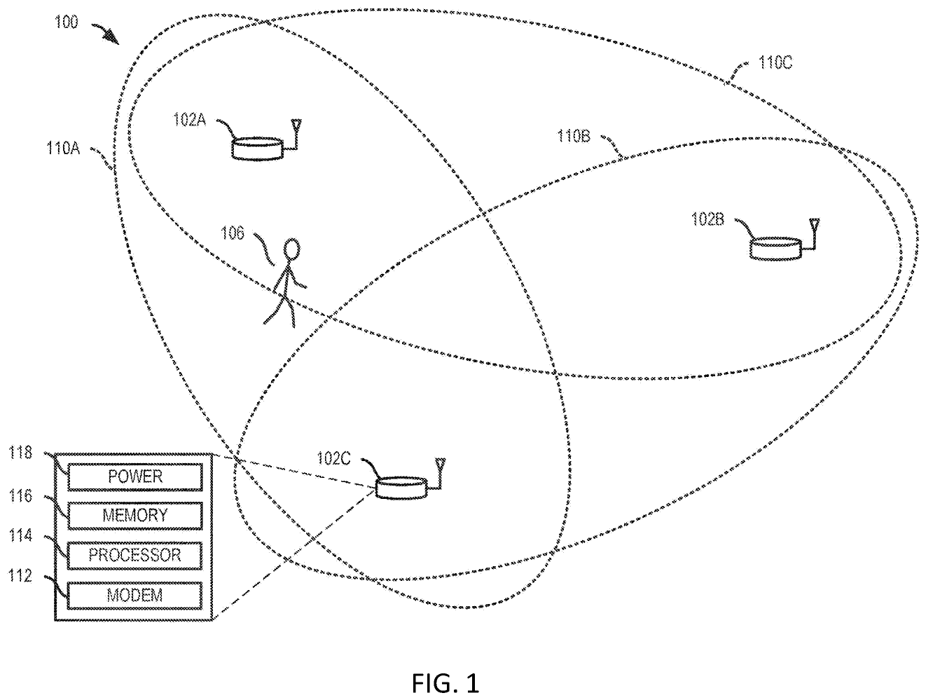

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF signals to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

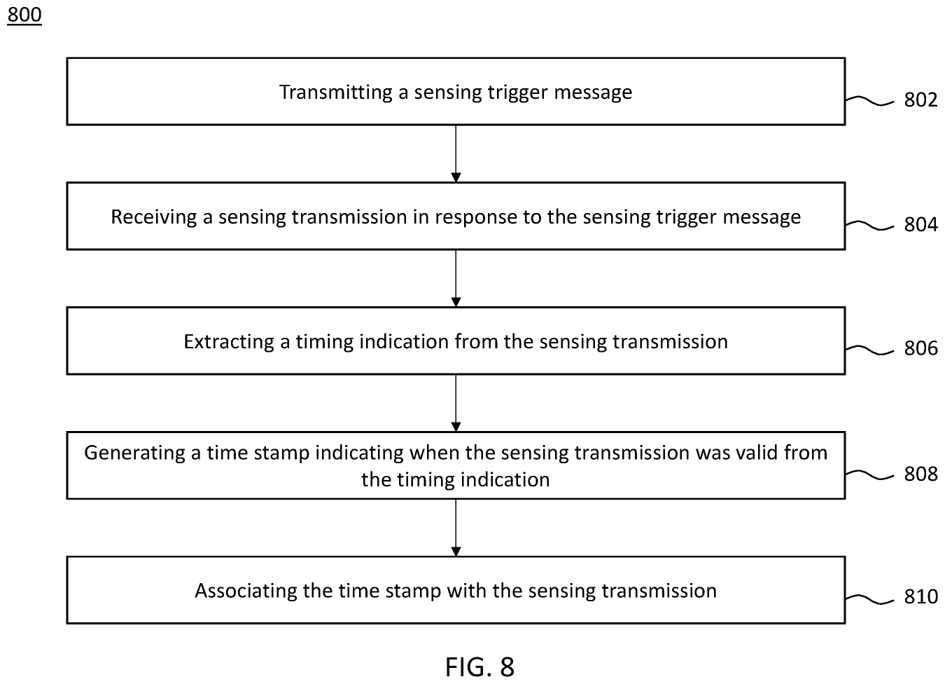

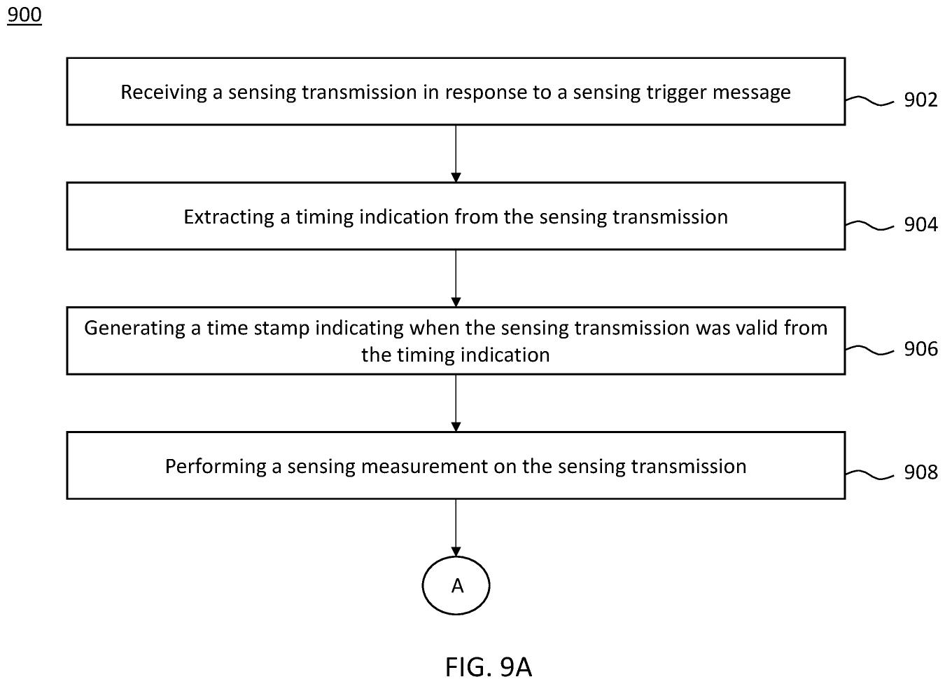

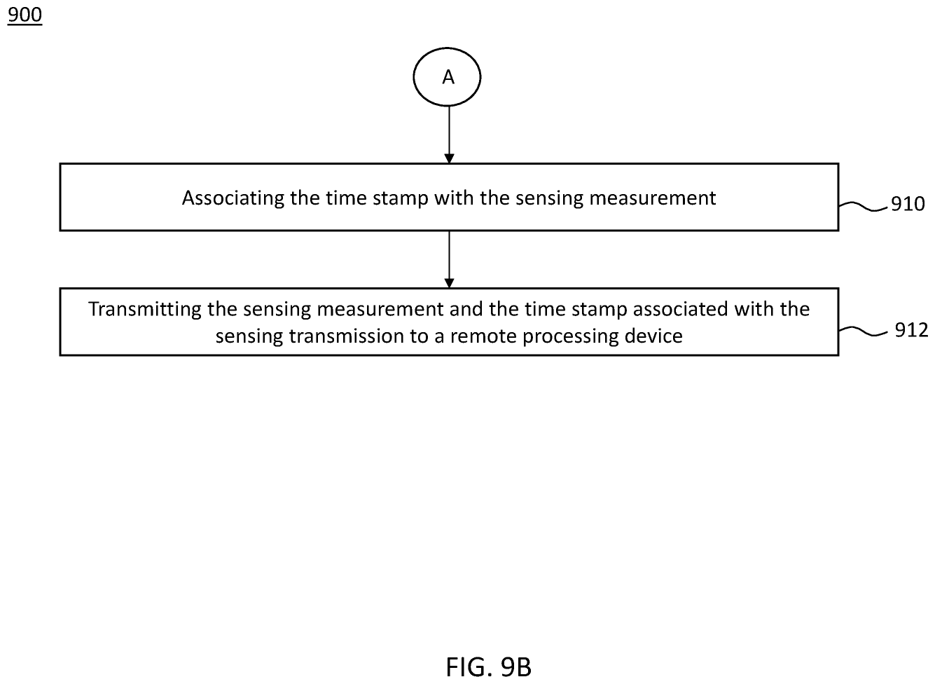

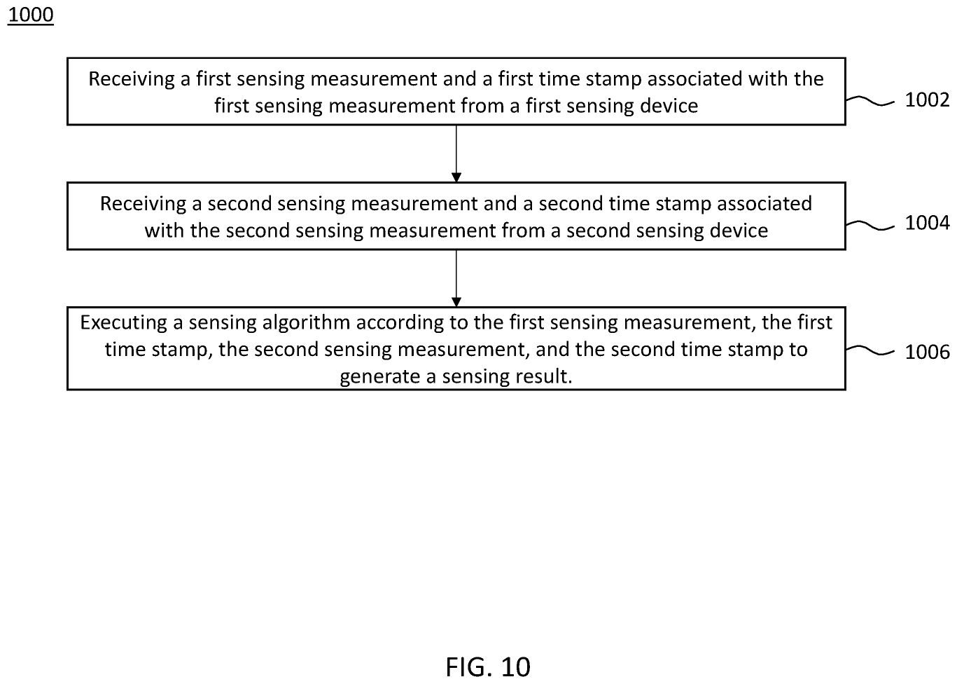

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIG. 8, FIG. 9A, FIG. 9B and FIG. 10.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIG. 8, FIG. 9A, FIG. 9B and FIG. 10, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly), an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

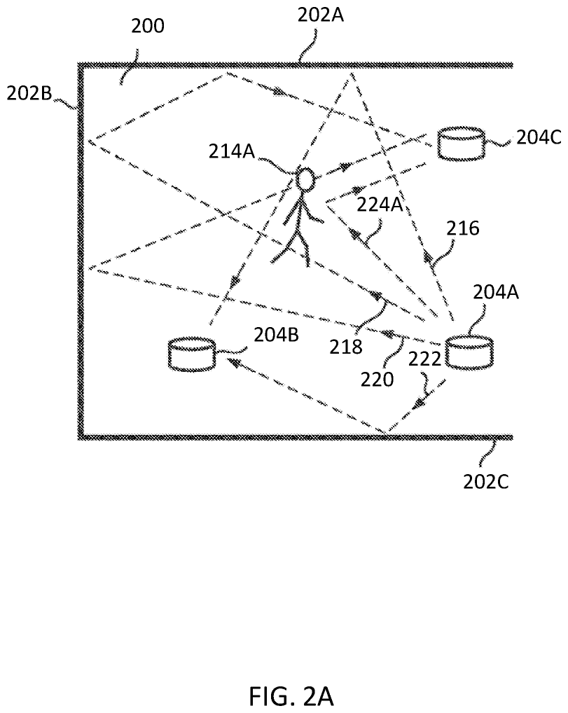

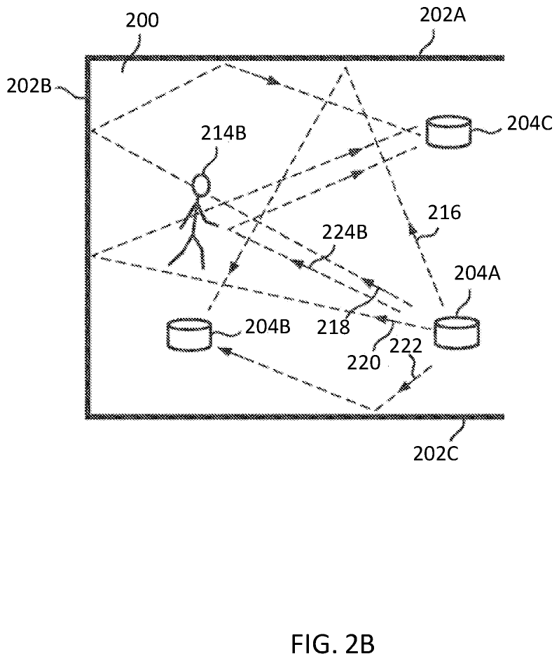

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

f(t)=Σ_{n=-∞}^{∞}cₙe^{jω}^{ₙ}^{t} (1)

Where ωₙ represents the frequency of nth frequency component of the transmitted signal, cₙ represents the complex coefficient of the nth frequency component, and t represents time. With f(t) being transmitted from the first wireless communication device 204A, an output signal rₖ(t) from a path, k, may be described according to Equation (2):

rₖ(t)=Σ_{n=-∞}^{∞}α_{n,k}cₙe^{j(ω}^{ₙ}^{t+ϕ}^{_{n,k}}⁾ (2)

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

R=Σₖrₖ(t) (3)

Substituting Equation (2) into Equation (3) renders the following Equation (4):

R=ΣₖΣ_{n=-∞}^{∞}(α_{n,k}e^{jϕ}^{_{n,k}})cₙe^{jω}^{ₙ}^{t} (4)

R at a wireless communication device can then be analyzed. R at a wireless communication device can be transformed to the frequency domain, for example, using a Fast Fourier Transform (FFT) or another type of algorithm. The transformed signal can represent R as a series of n complex values, one for each of the respective frequency components (at the n frequencies ωₙ). For a frequency component at frequency ωₙ, a complex value Hₙ may be represented as follows in Equation (5):

Hₙ=Σₖcₙα_{n,k}e^{jϕ}^{_{n,k}} (5)

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

h_{ch}=ΣₖΣ_{n=-∞}^{∞}α_{n,k} (6)

In some instances, the channel response, h_{ch}, for a space can be determined, for example, based on the mathematical theory of estimation. For instance, a reference signal R_{ef} can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

R_{cvd}=R_{ef}⊗h_{ch}=Σₖ₌₋ₘ^{m}R_{ef}(n−k)h_{ch}(k) (7)

with the optimization criterion

$${min}_{{h}_{ch}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

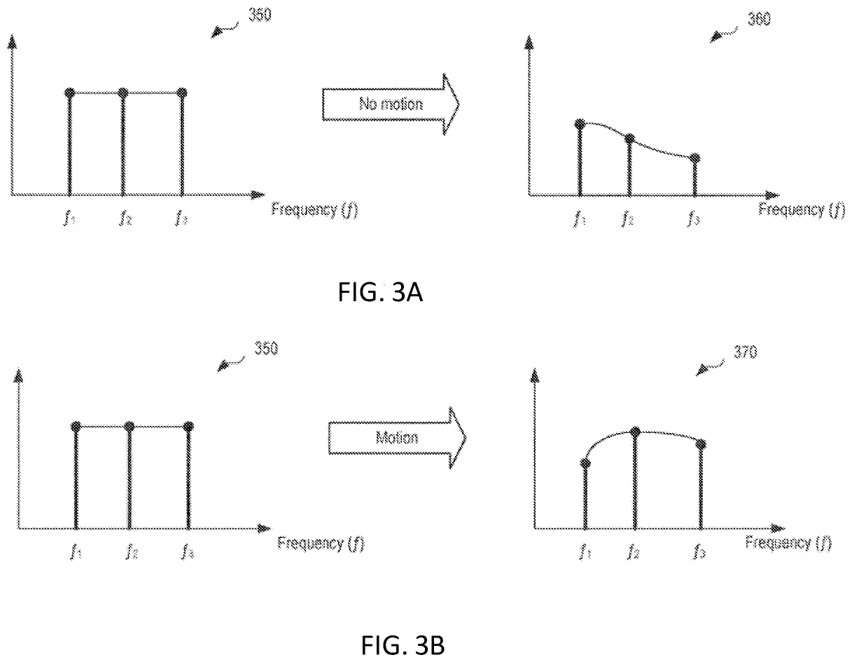

FIG. 3A and FIG. 3B are plots showing examples of channel response 360 and channel response 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel response 360 and channel response 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

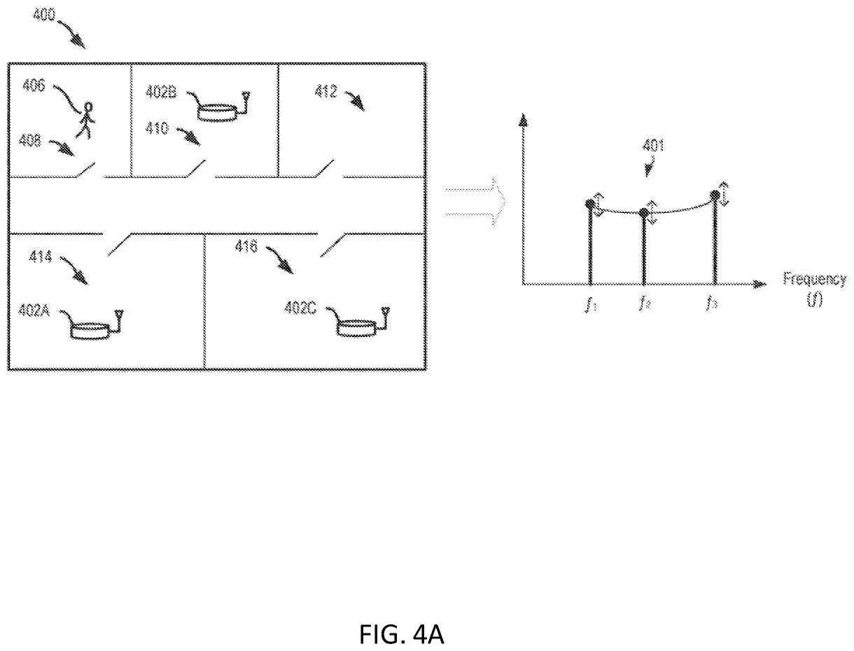

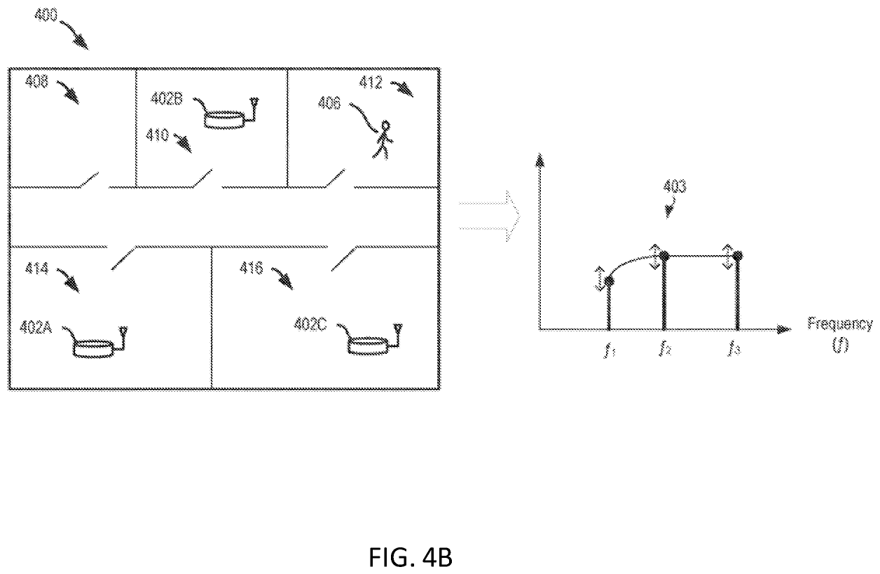

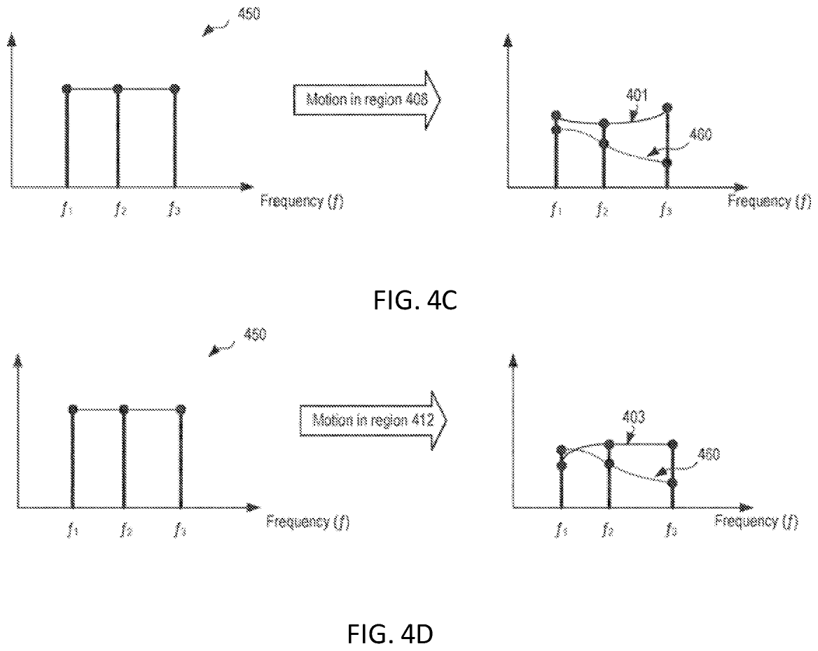

FIG. 4A and FIG. 4B are diagrams showing example channel response 401 and channel response 403 associated with motion of object 406 in distinct regions, first region 408 and third region 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel response 401 and channel response 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Systems and Methods to Perform Time Stamping of Wi-Fi Sensing Data

The following describes systems and methods for Wi-Fi sensing. The present disclosure relates to configuring Wi-Fi systems to perform time stamping of Wi-Fi sensing data.

The systems and methods of the present disclosure leverage a sensing device that may be configured to control a measurement campaign. In an implementation, the systems and the methods also leverage a remote device. The remote device may be configured to make sensing transmissions, and the sensing device may be configured to compute sensing measurements based on the sensing transmissions. In an implementation, the sensing device may be configured to generate time stamps for the sensing transmissions. In an example, the time stamps may be used for a variety of purposes, such as for synchronizing the sensing transmissions. According to an implementation, the sensing measurements are provided to a remote processing device for further processing such that for the purpose of achieving the objectives of the measurement campaign.

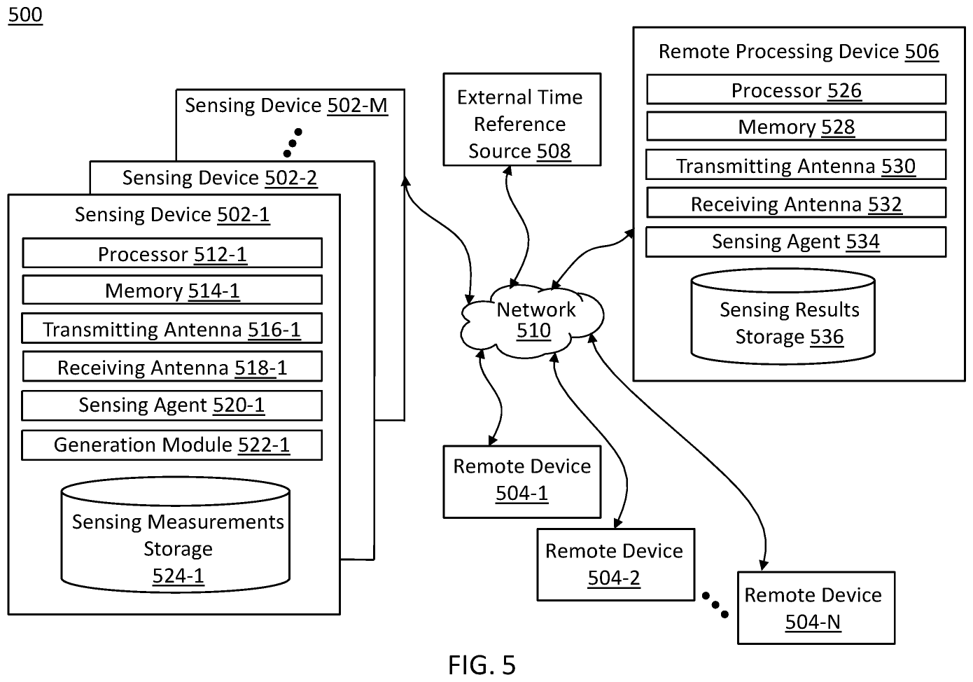

FIG. 5 depicts an implementation of some of an architecture of system 500 for time stamping of Wi-Fi sensing data, according to some embodiments.

System 500 (alternatively referred to as Wi-Fi sensing system 500) may include a plurality of sensing devices 502-(1-M) (collectively referred to as sensing device 502), plurality of remote devices 504-(1-N) (collectively referred to as remote device 504), remote processing device 506, external time reference source 508, and network 510 enabling communication between the system components for information exchange. System 500 may be an example or instance of wireless communication system 100 and network 510 may be an example or instance of wireless network or cellular network, details of which are provided with reference to FIG. 1 and its accompanying description. Although, it has been shown that system 500 includes plurality of sensing devices 502-(1-M), in some embodiments, system 500 may include only one sensing device, such as sensing device 502-1.

According to some embodiments, sensing device 502-1 may be configured to receive a sensing transmission and perform one or more measurements (for example, CSI) useful for Wi-Fi sensing. These measurements may be known as sensing measurements. In an embodiment, sensing device 502-1 may be an Access Point (AP). In some embodiments, sensing device 502-1 may be a Station (STA), for example, in a mesh network scenario. According to an implementation, sensing device 502-1 may be implemented by a device, such as wireless communication device 102 shown in FIG. 1. In some implementations, sensing device 502-1 may be implemented by a device, such as wireless communication device 204 shown in FIG. 2A and FIG. 2B. Further, sensing device 502-1 may be implemented by a device, such as wireless communication device 402 shown in FIG. 4A and FIG. 4B. In an implementation, sensing device 502-1 may coordinate and control communication among remote device 504. According to an implementation, sensing device 502-1 may be enabled to control a measurement campaign to ensure that required sensing transmissions are made at a required time and to ensure an accurate determination of sensing measurement. In some embodiments, sensing device 502-1 may process sensing measurements. In an embodiment, sensing device 502-1 may transmit the sensing measurements to another sensing device, such as sensing device 502-2, for processing of the sensing measurements. In some embodiments, sensing device 502-1 may be configured to transmit the sensing measurements to remote processing device 506. The sensing measurements may be processed to achieve a sensing result of system 500. According to an embodiment, each of plurality of sensing device 502-(2-M) may be configured to transmit the sensing measurements to remote processing device 506 for further processing.

Referring again to FIG. 5, in some embodiments, remote device 504-1 may be configured to send a sensing transmission to sensing device 502-1 based on which, one or more sensing measurements (for example, CSI) may be performed for Wi-Fi sensing. In an embodiment, remote device 504-1 may be an STA. In some embodiments, remote device 504-1 may be an AP for Wi-Fi sensing, for example in scenarios where sensing device 502-1 acts as STA. According to an implementation, remote device 504-1 may be implemented by a device, such as wireless communication device 102 shown in FIG. 1. In some implementations, remote device 504-1 may be implemented by a device, such as wireless communication device 204 shown in FIG. 2A and FIG. 2B. Further, remote device 504-1 may be implemented by a device, such as wireless communication device 402 shown in FIG. 4A and FIG. 4B. In some implementations, communication between sensing device 502-1 and remote device 504-1 may happen via Station Management Entity (SME) and MAC Layer Management Entity (MLME) protocols. According to an embodiment, each of plurality of remote device 504-(1-N) may be configured to send a sensing transmission to sensing device 502-1 based on which the sensing device 502-1 may compute the sensing measurement.

In some embodiments, remote processing device 506 may be configured to receive sensing measurements from one or more of plurality of sensing devices 502-(1-M) and process the sensing measurements to achieve a sensing result of system 500. In an example, remote processing device 506 may process and analyze the sensing measurement to achieve the sensing result of detecting a motion or a gesture. In an embodiment, remote processing device 506 may be an STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a Personal Digital Assistant (PDA) or any other computing device.

In an implementation, external time reference source 508 may provide a synchronized reference time signal to plurality of sensing devices 502-(1-M) and plurality of remote devices 504-(1-N). Examples of external time reference source 508 include a Coordinated Universal Time (UTC) reference source and a Global Positioning System (GPS) reference source.

Referring to FIG. 5, in more detail, sensing device 502-1 may include processor 512-1 and memory 514-1. For example, processor 512-1 and memory 514-1 of sensing device 502-1 may be processor 114 and memory 116, respectively, as shown in FIG. 1. In an embodiment, sensing device 502-1 may further include transmitting antenna(s) 516-1, receiving antenna(s) 518-1, sensing agent 520-1, generation module 522-1, and sensing measurements storage 524-1. In some embodiments, an antenna may be used to both transmit and receive signals in a half-duplex format. When the antenna is transmitting, it may be referred to as transmitting antenna 516-1 and when the antenna is receiving, it may be referred to as receiving antenna 518-1. It is understood by a person of normal skill in the art that the same antenna may be transmitting antenna 516-1 in some instances and receiving antenna 518-1 in other instances. In the case of an antenna array, one or more antenna elements may be used to transmit or receive a signal, for example, in a beamforming environment. In some examples, a group of antenna elements used to transmit a composite signal may be referred to as transmitting antenna 516-1 and a group of antenna elements used to receive a composite signal may be referred to as receiving antenna 518-1. In examples, each antenna is equipped with its own transmission and receive paths, which may be alternately switched to connect to the antenna depending on whether the antenna is operating as transmitting antenna 516-1 or receiving antenna 518-1.

In an implementation, sensing agent 520-1 (in examples, also known as Wi-Fi sensing agent or sensing application) may be an application layer program that passes physical layer parameters (e.g., such as CSI) from the Medium Access Control (MAC) layer of sensing device 502-1 to an application layer and/or another higher layer, and which uses the physical layer parameters to detect or determine movement and/or motion. In an example, the application layer or another higher layer may operate on the physical layer parameters and form services or features, which may be presented to an end-user. According to an implementation, communication between the MAC layer of sensing device 502-1 and other layers or components may take place based on communication interfaces, such as MLME interface and a data interface. Further, sensing agent 520-1 may be configured to determine a number and timing of sensing transmissions and sensing measurements for the purpose of Wi-Fi sensing. In some implementations, sensing agent 520-1 may be configured to transmit sensing measurements to another sensing device, such as any of sensing devices 502-(2-M) or remote processing device 506 for further processing.

In an implementation, sensing agent 520-1 may be configured to cause at least one transmitting antenna of transmitting antenna(s) 516-1 to transmit messages to remote device 504-1. Further, sensing agent 520-1 may be configured to receive, via at least one receiving antenna of receiving antennas(s) 518-1, messages from remote device 504-1. In an example, sensing agent 520-1 may be configured to make sensing measurements based on sensing transmissions received from remote device 504-1.

In an implementation, sensing agent 520-1 and generation module 522-1 may be coupled to processor 512-1 and memory 514-1. Generation module 522-1 may be configured to generate time stamps for sensing transmissions. In some embodiments, sensing agent 520-1 and generation module 522-1 amongst other units, may include routines, programs, objects, components, data structures, etc., which may perform particular tasks or implement particular abstract data types. Sensing agent 520-1 and generation module 522-1 may also be implemented as, signal processor(s), state machine(s), logic circuitries, and/or any other device or component that manipulate signals based on operational instructions.

In some embodiments, generation module 522-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, generation module 522-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 514-1.

In an implementation, sensing measurements storage 524-1 may store sensing measurements computed by sensing device 502-1 based on sensing transmissions. Information regarding the sensing measurements stored in sensing measurements storage 524-1 may be periodically or dynamically updated as required. In an implementation, sensing measurements storage 524-1 may include any type or form of storage, such as a database or a file system coupled to memory 514-1

Referring again to FIG. 5, remote processing device 506 may include processor 526 and memory 528. For example, processor 526 and memory 528 of remote processing device 506 may be processor 114 and memory 116, respectively, as shown in FIG. 1. In an embodiment, remote processing device 506 may further include transmitting antenna(s) 530, receiving antenna(s) 532, and sensing agent 534.

In an implementation, sensing agent 534 may be an application layer program that passes physical layer parameters from the MAC layer of remote processing device 506 to the application layer and/or another higher layer. According to some implementations, sensing agent 534 may include/execute a sensing algorithm. In an implementation, sensing agent 534 may process and analyze the sensing measurement using the sensing algorithm, and generate sensing results, such as detecting motions or gestures.

In some embodiments, remote processing device 506 may include sensing results storage 536. Sensing results storage 536 may store sensing results generated based on one or more sensing measurements. Information regarding the sensing results stored in sensing results storage 536 may be periodically or dynamically updated as required. In an implementation, sensing results storage 536 may include any type or form of storage, such as a database or a file system coupled to memory 528.

Although it has been described that sensing device 502-1 makes/performs sensing measurements on sensing transmissions received from remote device 504 and transmits the sensing measurements to remote processing device 506 for further processing, according to some embodiments, the sensing measurements may be made and processed by the same device, such as any sensing device from amongst plurality of sensing devices 502-(1-M). In an implementation, the MAC and PHY layers of the respective devices may be used to coordinate and perform the sensing measurements between multiple devices. In an example, sensing device 502-1 may make and process the sensing measurements. In an implementation, the MAC layer may send information regarding the sensing measurements to sensing agent 520-1 via the MLME interface. Sensing agent 520-1 may process the information regarding the sensing measurements to generate the sensing result.

According to one or more implementations, communications in network 510 may be governed by one or more of the 802.11 family of standards developed by IEEE. Some example IEEE standards may include IEEE P802.11-REVmd/D5.0, IEEE P802.11ax/D7.0, and IEEE P802.11be/D0.1. In some implementations, communications may be governed by other standards (other or additional IEEE standards or other types of standards). In some embodiments, parts of network 510 which are not required by system 500 to be governed by one or more of the 802.11 family of standards may be implemented by an instance of any type of network, including wireless network or cellular network.

In an implementation, plurality of sensing devices 502-(1-M) and plurality of remote devices 504-(1-N) may form a part of a BSS. According to IEEE 802.11 standard, a TSF Timer (alternatively referred to as system clock) of each individual device within the BSS (i.e., each of plurality of sensing devices 502-(1-M) and each of plurality of remote devices 504-(1-N)) is synchronized to within a predefined tolerance value using the TSF along with synchronizing beacon frames. In an example, the predefined tolerance value may be ±100 ppm. In an implementation, a value of the TSF Timer of plurality of sensing devices 502-(1-M) and plurality of remote devices 504-(1-N) may be identical and within the predefined tolerance value of the TSF. According to an example, the value of the TSF Timer may be associated with a reference time in real-time, such as UTC, GPS time, or a network time derived from a Network Time Protocol (NTP) server. According to an implementation, the value of the TSF Timer may be associated to the reference time based on Timing Advertisement (TA) feature specified in IEEE 802.11 standard. In some implementations, sensing device 502-1 may be a controlling device for the reference time. In an implementation, external time reference source 508 may provide a synchronized reference time signal to sensing device 502-1. In response to receiving the synchronized reference time signal, sensing device 502-1 may process the synchronized reference time signal to generate one or more TA messages in accordance with the reference time included in the synchronized reference time signal. In an implementation, in scenarios where plurality of sensing devices 502-(1-M) are not part of the same BSS, external time reference source 508 may provide a synchronized reference time signal to each of plurality of sensing devices 502-(1-M), thus ensuring that each of plurality of sensing devices 502-(1-M) may be synchronized to a common time (for example, UTC) within the predefined tolerance value.

According to an implementation, for the purpose of Wi-Fi sensing, sensing device 502-1 may initiate a measurement campaign. In the measurement campaign, exchange of sensing transmissions between sensing device 502-1 and remote device 504-1 may occur. In an example, control of these transmissions may be with the MAC (Medium Access Control) layer of the IEEE 802.11 stack.

According to an implementation, sensing device 502-1 may initiate sensing transmissions via one or more sensing trigger messages. In an implementation, sensing agent 520-1 may be configured to generate a sensing trigger message. Sensing agent 520-1 may be configured to generate the sensing trigger message based on a transmission capability of remote device 504-1 and/or a requested transmission configuration. In an example, the sensing trigger message may include a requested transmission configuration not exceeding the transmission capability of remote device 504-1. Other examples of information/data included in the sensing trigger message that are not discussed here are contemplated herein. For example, if remote device 504-1 supports 5 GHz frequency band and implements four transmitting antennas, then sensing agent 520-1 may generate the sensing trigger message requiring a sensing transmission in 5 GHz frequency band using four transmitting antennas. In an implementation, sensing agent 520-1 may transmit the sensing trigger message to remote device 504-1 via transmitting antenna 516-1.

In an implementation, remote device 504-1 may receive the sensing trigger message from sensing device 502-1. In some implementations, remote device 504-1 may apply the requested transmission configuration included in the sensing trigger message. According to one or more implementations, remote device 504-1 may generate one of a sensing response message and a sensing response NDP as a sensing transmission in response to the sensing trigger message. In an implementation, remote device 504-1 may generate the sensing response message when the requested transmission configuration supports data transfer. In some implementations, remote device 504-1 may generate the sensing response NDP when the requested transmission configuration does not support data transfer. In an implementation, the sensing response message may include delivered transmission configuration/requirements, which describe transmission parameters that remote device 504-1 used when transmitting the sensing transmission.

According to an implementation, remote device 504-1 may generate a sensing response announcement. In an example, the sensing response announcement may include a delivered transmission configuration that will be applied to the sensing response NDP. In an implementation, remote device 504-1 may generate the sensing response NDP, which may be transmitted after one SIFS of the sensing response announcement. In an example, the duration of SIFS is 10 μs. According to an example, the sensing response message and/or the sensing response NDP may be the sensing transmission from which sensing device 502-1 may make a sensing measurement. In an implementation, the sensing response message and/or the sensing response NDP may be encoded sensing transmissions. In some examples, the sensing response message may include data, and the sensing response NDP may not include data. In an embodiment, where the sensing transmission is also capable of carrying data, the transmission parameters used to generate and transmit the sensing transmission may be encoded into a data frame carried by a sensing response message. In some embodiments, where the sensing transmission cannot carry data, the transmission parameters used to generate and transmit the sensing transmission may be encoded into a data frame carried by a sensing response announcement. In an implementation, remote device 504-1 may transmit the sensing transmission to sensing device 502-1.

According to an implementation, sensing device 502-1 may receive the sensing transmission from remote device 504-1 transmitted in response to the sensing trigger message. In an implementation, sensing device 502-1 may receive the sensing transmission from remote device 504-1 via receiving antenna 518-1. In an example, the sensing transmission may include one of the sensing response message and the sensing response NDP as the sensing transmission. In an implementation, prior to receiving the sensing response NDP as the sensing transmission, sensing device 502-1 may receive the sensing response announcement.

In response to receiving the sensing transmission, sensing agent 520-1 may decode the sensing transmission. According to an implementation, the sensing transmission may include one or more training fields which may be used by sensing agent 520-1 to perform a sensing measurement. According to an example, the one or more training fields may be configured in the requested transmission configuration or identified in the delivered transmission configuration of the sensing response message or the sensing response announcement. In an example, in scenarios where the sensing transmission includes more than one training field, a message (i.e., the sensing response message or the sensing response announcement which precedes the sensing response NDP) may identify which training field is to be used by sensing agent 520-1 for performing the sensing measurement. In some examples, sensing agent 520-1 may use a first received training field or a training field that results in a highest precision sensing measurement for performing the sensing measurement. According to an implementation, sensing agent 520-1 may identify from the reception of the sensing response message and/or the sensing response NDP that it has received the sensing transmission. On receiving the sensing transmission, sensing agent 520-1 may perform the sensing measurement on a training field of the sensing transmission.

In an implementation, the MLME of sensing device 502-1 may identify a timing indication in the sensing response message. For example, the timing indication may be an epoch, event, or other data indicative of timing (e.g., indicative of sensing transmission generation or transmission) of the sensing transmission applied by remote device 504-1 in the received sensing transmission. In further examples, the timing indication may include an identifiable signal pattern, such as a particular pattern of bits. For example, identifying the timing indication may include determining a time, based on the time value of the TSF timer, at which the timing indication was received at a reference point. For example, the timing indication may be a first bit of the training field and the time determined according to the timing indication may be indicative of a time when the first bit of the training field of the sensing transmission is received. In another example, the timing indication may be a specific bit of the training field and the time determined according to the timing indication may be indicative of a time when the specific bit of the training field of the sensing transmission is received. In another example, the timing indication may be a specific combination of bits of the training field and the time determined according to the timing indication may be indicative of a time when the specific combination of bits of the training field of the sensing transmission is received.

In an implementation, the MLME of sensing device 502-1 may generate a time stamp according to the timing indication indicating when the sensing transmission was valid from the time value of the TSF Timer, i.e., as determined during identification of the timing indication. According to an implementation, the MLME of sensing device 502-1 may generate the time stamp by applying a propagation correction to the time or the time value. In an implementation, the MLME of sensing device 502-1 may generate the time stamp by identifying the time value according to the identified timing indication and adjusting the time value by applying the propagation correction. According to a further implementation, the MLME of sensing device 502-1 may generate the time stamp to be associated with the sensing response message by generating a time stamp according to the time value of the TSF timer and adjusting the time stamp by applying the propagation correction.

In some implementations, generation module 522-1 may apply an offset to the time stamp. In an implementation, external time reference source 508 may synchronize the TSF Timer of sensing device 502-1 to a reference time via the offset. For example, in scenarios where the TSF Timer is synchronized to a reference time (such as UTC reference time), then an offset from the reference time and the TSF Timer value may have a separate value, such as a fixed value or a periodically updated value to move the TSF Timer to the reference time. In an implementation, generation module 522-1 may associate the offset value (i.e., the value that fixes the TSF Timer to the reference time) with the sensing measurement. In some scenarios, the TSF Timer value and the reference time offset value require scaling to a common precision. For example, the reference time offset value may be provided by the TA feature (specified in IEEE 802.11 standard) where it is made available as a value in nanoseconds and the TSF Timer value may be provided by the TSF where it is made available as a value in microseconds. In such scenarios, generation module 522-1 may scale back the reference time offset value to microseconds by dividing by 1000. In some embodiments, generation module 522-1 may convert the time stamp into a real-time value (such as a date and time format defined by American National Standards Institute (ANSI)). In an implementation, generation module 522-1 may apply the offset to a time determined according to the timing indication to generate the time stamp. According to a further implementation, the generation module 522-1 may generate the time stamp to be associated with the sensing response message by generating a time stamp according to the identified timing indication and applying the offset to the time stamp.

According to an implementation, generation module 522-1 may use the TSF and its associated TSF Timer to generate the time stamp for the sensing transmission received by sensing device 502-1 from remote device 504-1. In some embodiments, other timing systems may be considered for use. For example, the Timing Measurement system described in IEEE 802.11 standard or the Fine Timing Measurement system described in IEEE 802.11 standard may be used. In some embodiments, plurality of remote devices 504-(1-N) may be directly synchronized to external time reference source 508.

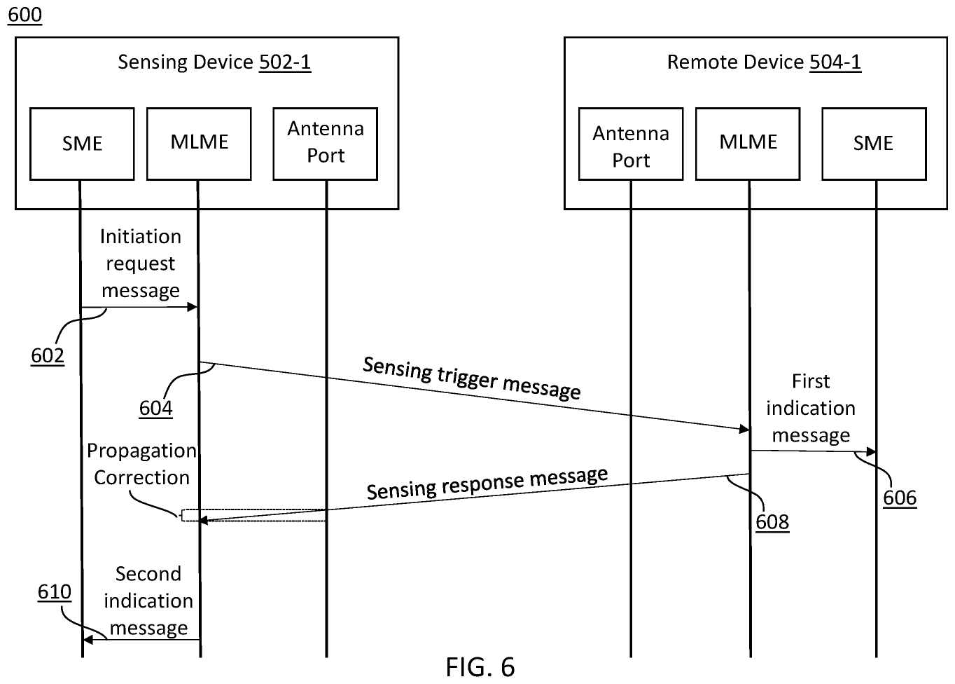

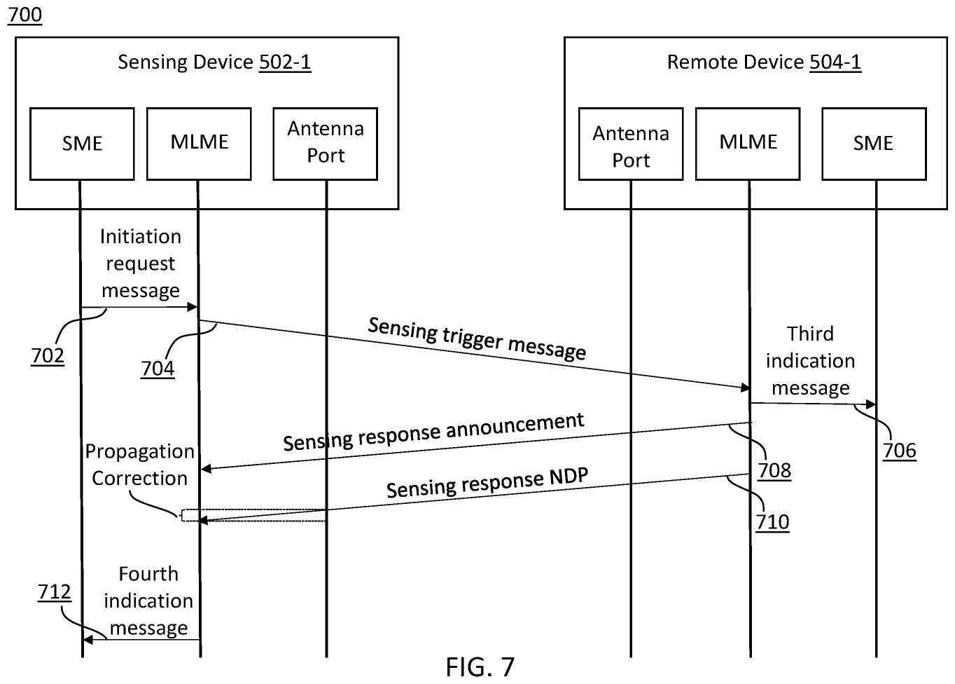

The manner in which sensing device 502-1 generates the time stamp is described in greater detail in conjunction with FIG. 6 and FIG. 7. Further, in a similar manner as described above, sensing device 502-1 may receive sensing transmissions from remaining remote devices 504-(2-N) and sensing device 502-1 may perform the sensing measurements on the sensing transmissions and generate the time stamps.

In an implementation, sensing agent 520-1 may associate the time stamp with the sensing measurement. Further, sensing agent 520-1 may store the sensing measurement and the time stamp associated with the sensing measurement in sensing measurements storage 524-1 for future use. Subsequently, sensing agent 520-1 may transmit the sensing measurement and the time stamp associated with the sensing measurement to remote processing device 506 via transmitting antenna 516-1. In an implementation, remote processing device 506 may receive respective time stamps and sensing measurements from each of plurality of sensing devices 502-(1-M). In an example, the time stamps of the plurality of sensing measurements from sensing devices 502-(1-M) may have a common time reference to ensure that the plurality of sensing measurements can be aligned in time at remote processing device 506.

According to an implementation, remote processing device 506 may receive a first sensing measurement and a first time stamp associated with the first sensing measurement from a first sensing device. In an example, the first sensing device may be sensing device 502-1. Further, remote processing device 506 may receive a second sensing measurement and a second time stamp associated with the second sensing measurement from a second sensing device. In an example, the second sensing device may be sensing device 502-2. In an implementation, remote processing device 506 may receive the first sensing measurement, the first time stamp, the second sensing measurement, and the second time stamp via receiving antenna 532.

In an implementation, sensing agent 534 may execute a sensing algorithm according to the first sensing measurement, the first time stamp, the second sensing measurement, and the second time stamp to generate a sensing result, such as detecting motions or gestures. In an example, sensing agent 534 may be configured to process the first sensing measurement, the first time stamp, the second sensing measurement, and the second time stamp into motion or context-aware information.

Further, sensing agent 534 may store the sensing result in sensing results storage 536 for future use. According to an implementation, sensing agent 534 may transmit the sensing result to a third sensing device via transmitting antenna 530. In an example, the third sensing device may be sensing device 502-3.

FIG. 6 depicts a sequence diagram 600 for application of propagation correction on a sensing response message received by sensing device 502-1 from remote device 504-1, according to some embodiments.

As shown in FIG. 6, at step 602, the SME of sensing device 502-1 may send an initiation request message to the MLME of sensing device 502-1. In an example, the initiation request message may be indicative of a request to initiate a sensing transmission for Wi-Fi sensing. At step 604, in response to receiving the initiation request message, the MLME of sensing device 502-1 may send a sensing trigger message to remote device 504-1 to initiate the sensing transmission. As can be seen in FIG. 6, the MLME of sensing device 502-1 sends the sensing trigger message to the MLME of remote device 504-1 via a reference point (for example, an antenna port) of sensing device 502-1. In an example, the sensing trigger message may include a requested transmission configuration not exceeding transmission capability of remote device 504-1. At step 606, in response to receiving the sensing trigger message, the MLME of remote device 504-1 may send a first indication message to the SME of remote device 504-1. In an example, the first indication message may be indicative of reception of the sensing trigger message. In an implementation, the MLME of remote device 504-1 may receive the sensing trigger message via a a reference point (for example, an antenna port) of remote device 504-1.

At step 608, the MLME of remote device 504-1 may send a sensing response message to the MLME of sensing device 502-1 via the reference point of remote device 504-1. According to an implementation, the MLME of sensing device 502-1 may receive the sensing response message from remote device 504-1 via the reference point of sensing device 502-1. Further, the MLME of sensing device 502-1 may identify from the reception of the sensing response message that it has received a sensing transmission. In an example, the sensing response message may include a training field. The MLME of sensing device 502-1 may perform the sensing measurement on the sensing response message.

In an implementation, the MLME of sensing device 502-1 may identify a timing indication in the sensing response message. In an implementation, the MLME of sensing device 502-1 may generate a time stamp according to the timing indication indicating when the sensing transmission was valid from the time value of the TSF Timer. For example, identifying the timing indication may include determining a time, based on the time value of the TSF timer, at which the timing indication was received at a reference point. According to an implementation, the MLME of sensing device 502-1 may generate the time stamp by applying a propagation correction to the time or the time value. In an implementation, the MLME of sensing device 502-1 may generate the time stamp by identifying the time value according to the timing indication and adjusting the time value by applying the propagation correction. According to a further implementation, the MLME of sensing device 502-1 may generate the time stamp to be associated with the sensing response message by generating a time stamp according to the time value of the TSF timer and adjusting the time stamp by applying the propagation correction.

According to an implementation, the MLME of sensing device 502-1 may apply the propagation correction such that the time stamp represents a reception time at which the timing indication is received at the reference point of sensing device 502-1. As can be seen in FIG. 6, the MLME of sensing device 502-1 applies the propagation correction to the sensing response message received at the reference point of sensing device 502-1. In an example, the propagation correction may be indicative of a propagation time of the sensing response message through a receive chain of the sensing device 502-1. The propagation correction may further be indicative of a transmission time through space of the sensing response message, in the case where the timing indication is an epoch, event, or other data indicative of timing at remote device 504-1.

In an example, the receive chain of sensing device 502-1 may include analog elements and digital elements. For example, the receive chain may include the analog and digital components through which a received signal may travel from a reference point, i.e., an antenna port, to a point at which the received signal may be read, i.e., by a sensing agent 520-1 of the sensing device 502-1. In an implementation, the MLME of sensing device 502-1 may calculate a digital propagation delay relative to a digital processing clock of sensing device 502-1 based on its design. Further, the MLME of sensing device 502-1 may synchronize the digital processing clock in accordance with the TSF Timer. Further, in an implementation, the MLME of sensing device 502-1 may calculate an approximate analog propagation delay corresponding to the time taken for a signal to pass through the analog elements of the receive chain of sensing device 502-1. In an example, the analog propagation delay may be calculated by approximation based on design of the analog elements or by a calibration operation.

Further, the MLME of remote device 504-1 may use the same mechanism described to correct for the propagation delay of the beacon message that synchronises the TSF Timer. According to an implementation, once the MLME of sensing device 502-1 generates the time stamp of the sensing measurement, the MLME of sensing device 502-1 may associate a value of the time stamp with the sensing measurement. At step 610, the MLME of sensing device 502-1 may send a second indication message to the SME of sensing device 502-1. In an example, the second indication message may include the sensing measurement and the time stamp associated with the sensing measurement.

FIG. 7 depicts a sequence diagram 700 for application of propagation correction on a sensing response NDP received by sensing device 502-1 from remote device 504-1, according to some embodiments.

As shown in FIG. 7, at step 702, the SME of sensing device 502-1 may send an initiation request message to the MLME of sensing device 502-1. In an example, the initiation request message may be indicative of a request to initiate a sensing transmission for Wi-Fi sensing. At step 704, in response to receiving the initiation request message, the MLME of sensing device 502-1 may send a sensing trigger message to remote device 504-1 to initiate the sensing transmission. As can be seen in FIG. 7, the MLME of sensing device 502-1 sends the sensing trigger message to the MLME of remote device 504-1 via a reference point (for example, an antenna port) of sensing device 502-1. At step 706, in response to receiving the sensing trigger message, the MLME of remote device 504-1 may send a third indication message to the SME of remote device 504-1. In an example, the third indication message may be indicative of the reception of the sensing trigger message. In an implementation, the MLME of remote device 504-1 may receive the sensing trigger message via a reference point (for example, an antenna port) of remote device 504-1.

At step 708, the MLME of remote device 504-1 may send a sensing response announcement to the MLME of sensing device 502-1 via the reference point of remote device 504-1. According to an implementation, the MLME of sensing device 502-1 may receive the sensing response announcement from remote device 504-1 via the reference point of sensing device 502-1. In an implementation, the MLME of sensing device 502-1 may identify from the reception of the sensing response announcement that it will be receiving a sensing response NDP after one SIFS.

At step 710, the MLME of remote device 504-1 may send the sensing response NDP to the MLME of sensing device 502-1 via the reference point of remote device 504-1 after one SIFS. According to an implementation, the MLME of sensing device 502-1 may receive the sensing response NDP from remote device 504-1 via the reference point of sensing device 502-1. Further, the MLME of sensing device 502-1 may identify from the reception of the sensing response NDP that it has received a sensing transmission. In an example, the sensing response NDP may include a training field. The MLME of sensing device 502-1 may perform the sensing measurement on the sensing response NDP.

In an implementation, the MLME of sensing device 502-1 may identify a timing indication from the sensing response NDP used to make the sensing measurement. In an implementation, the MLME of sensing device 502-1 may generate a time stamp according to the timing indication indicating when the sensing transmission was valid from the time value of the TSF Timer. For example, identifying the timing indication may include determining a time, based on the time value of the TSF timer, at which the timing indication was received at a reference point. According to an implementation, the MLME of sensing device 502-1 may generate the time stamp by applying a propagation correction to the time or the time value. In an implementation, the MLME of sensing device 502-1 may generate the time stamp by identifying the time value according to the timing indication and adjusting the time value by applying the propagation correction. According to a further implementation, the MLME of sensing device 502-1 may generate the time stamp to be associated with the sensing response NDP by generating a time stamp according to the time value of the TSF timer and adjusting the time stamp by applying the propagation correction. As can be seen in FIG. 7, the MLME of sensing device 502-1 applies the propagation correction to the sensing response NDP received at the reference point of sensing device 502-1.

According to an implementation, once the MLME of sensing device 502-1 generates the time stamp of the sensing measurement, the MLME of sensing device 502-1 may associate a value of the time stamp with the sensing measurement. At step 712, the MLME of sensing device 502-1 may send a fourth indication message to the SME of sensing device 502-1. In an example, the fourth indication message may include the sensing measurement and the time stamp associated with the sensing measurement.

According to aspects of the present disclosure, system 500 may use the time stamp for synchronizing sensing transmissions made from plurality of remote devices 504-(1-N) to a plurality of sensing devices 502-(1-M). The time stamps have a common time reference to ensure that sensing measurements can be aligned in time at a receiving device, for example, remote processing device 506. Further, since the TSF Timer maintained by sensing device 502-(1-M) is accurate and the reference point of time stamp is consistent, system 500 is enabled to compensate/remove the measurement time jitter and ensures that processing in both time and frequency is accurate, resulting in a more accurate representation of the CSI.

FIG. 8 depicts flowchart 800 for generating a time stamp for a sensing transmission, according to some embodiments.

Step 802 includes transmitting a sensing trigger message. In an implementation, sensing agent 520-1 may transmit the sensing trigger message to remote device 504-1 to initiate one or more sensing transmissions for Wi-Fi sensing.

Step 804 includes receiving a sensing transmission in response to the sensing trigger message. The sensing transmission may include one or more training fields. In an example, the sensing transmission may include a sensing response message and/or a sensing response NDP. In an implementation, sensing agent 520-1 may receive the sensing transmission from remote device 504-1 transmitted in response to the sensing trigger message.

Step 806 includes identifying a timing indication from the sensing transmission. In an example, the timing indication may be an epoch, event, or other data indicative of timing (e.g., indicative of sensing transmission generation or transmission) of the sensing transmission applied by remote device 504-1 in the received sensing transmission. In further examples, the timing indication may include an identifiable signal pattern, such as a particular pattern of bits. For example, identifying the timing indication may include determining the time at which the timing indication is received at a reference point. According to an implementation, sensing agent 520-1 of sensing device 502-1 may identify the timing indication in the sensing transmission.

Step 808 includes generating a time stamp indicating when the sensing transmission was valid from the timing indication. In an implementation, generation module 522-1 may generate a time stamp indicating when the sensing transmission was valid from the timing indication. Generation module 522-1 may apply a propagation correction to the time stamp. In an example, the propagation correction may be indicative of a propagation time through a receive chain of sensing device 502-1. The propagation correction may further be indicative of a transmission time through space of the sensing transmission, in the case where the timing indication is an epoch, event, or other data indicative of timing at remote device 504-1. According to an implementation, generation module 522-1 may apply the propagation correction such that the time stamp represents a reception time at which the timing indication is received at an reference point of sensing device 502-1. In an implementation, the TSF Timer of sensing device 502-1 may be synchronized to a reference time (such as UTC reference time) provided by external time reference source 508. In an example, the reference point of sensing device 502-1 may be an antenna port.

Step 810 includes associating the time stamp with the sensing transmission. In an implementation, sensing agent 520-1 of sensing device 502-1 may associate the time stamp with the sensing transmission.

FIG. 9A and FIG. 9B depict flowchart 900 for generating a time stamp for a sensing transmission to be transmitted to remote processing device 506, according to some embodiments.

Step 902 includes receiving a sensing transmission in response to a sensing trigger message. The sensing transmission may include one or more training fields. In an example, the sensing transmission may include a sensing response message and/or a sensing response NDP. In an implementation, sensing agent 520-1 of sensing device 502-1 may receive the sensing transmission from remote device 504-1 transmitted in response to the sensing trigger message.

Step 904 includes identifying a timing indication from the sensing transmission. In an example, the timing indication may be an epoch, event, or other data indicative of timing (e.g., indicative of sensing transmission generation or transmission) of the sensing transmission applied by remote device 504-1 in the received sensing transmission. In further examples, the timing indication may include an identifiable signal pattern, such as a particular pattern of bits. For example, identifying the timing indication may include determining the time at which the timing indication is received at a reference point. According to an implementation, sensing agent 520-1 of sensing device 502-1 may identify the timing indication from the sensing transmission.

Step 906 includes generating a time stamp indicating when the sensing transmission was valid from the timing indication. In an implementation, generation module 522-1 of sensing device 502-1 may generate a time stamp indicating when the sensing transmission was valid from the timing indication. Generation module 522-1 may generate the time stamp by applying a propagation correction to a time determined based on identification of the timing indication. In an example, the propagation correction may be indicative of a propagation time through a receive chain of sensing device 502-1. The propagation correction may further be indicative of a transmission time through space of the sensing response message, in the case where the timing indication is an epoch, event, or other data indicative of timing at remote device 504-1. According to an implementation, generation module 522-1 of sensing device 502-1 may apply the propagation correction such that the time stamp represents a reception time at which a training field of the sensing transmission used to perform a sensing measurement is received at a reference point of sensing device 502-1. In some implementations, generation module 522-1 of sensing device 502-1 may apply an offset to the time determined according to identification of the timing indication to generate the time stamp. In an example, the reference point of sensing device 502-1 may be an antenna port.

Step 908 includes performing a sensing measurement on the sensing transmission. In an implementation, sensing agent 520-1 of sensing device 502-1 may perform the sensing measurement on the sensing transmission. According to an implementation, sensing agent 520-1 of sensing device 502-1 may perform the sensing measurement on a training field of the sensing transmission.

Step 910 includes associating the time stamp with the sensing measurement. According to an implementation, sensing device 502-1 may associate the time stamp with the sensing measurement.

Step 912 includes transmitting the sensing measurement and the time stamp associated with the sensing transmission to remote processing device 506. According to an implementation, sensing agent 520-1 of sensing device 502-1 may transmit the sensing measurement and the time stamp associated with the sensing transmission to remote processing device 506.

FIG. 10 depicts flowchart 1000 for executing a sensing algorithm to generate a sensing result, according to some embodiments.

Step 1002 includes receiving a first sensing measurement and a first time stamp associated with the first sensing measurement from a first sensing device. In an example, the first sensing device may be sensing device 502-1. According to an implementation, sensing agent 534 of remote processing device 506 may receive the first sensing measurement and the first time stamp associated with the first sensing measurement from the first sensing device.

Step 1004 includes receiving a second sensing measurement and a second time stamp associated with the second sensing measurement from a second sensing device. In an example, the second sensing device may be sensing device 502-2. According to an implementation, sensing agent 534 of remote processing device 506 may receive the second sensing measurement and the second time stamp associated with the second sensing measurement from the second sensing device.

Step 1006 includes executing a sensing algorithm according to the first sensing measurement, the first time stamp, the second sensing measurement, and the second time stamp to generate a sensing result. According to an implementation, sensing agent 534 of remote processing device 506 may execute the sensing algorithm according to the first sensing measurement, the first time stamp, the second sensing measurement, and the second time stamp to generate the sensing result. In an implementation, sensing agent 534 of remote processing device 506 may transmit the sensing result to a third sensing device. In an example, the third sensing device may be sensing device 502-3.

Specific embodiments include:

Embodiment 1 is a system comprising a sensing device including at least one transmitting antenna, at least one receiving antenna, and at least one processor, wherein the at least one processor is configured to execute instructions to cause the at least one transmitting antenna to transmit a sensing trigger message, receive, via the at least one receiving antenna, a sensing transmission transmitted in response to the sensing trigger message, identify a timing indication in the sensing transmission, generate a time stamp indicating when the sensing transmission was valid from the timing indication, and associate the time stamp with the sensing transmission.

Embodiment 2 is the system of embodiment 1, wherein the at least one processor is further configured to execute instructions to perform a sensing measurement on the sensing transmission, and associate the time stamp with the sensing measurement.

Embodiment 3 is the system of embodiment 2, wherein the sensing measurement is performed using a training field of the sensing transmission.

Embodiment 4 is the system of any of embodiment 1 to embodiment 3, wherein prior to the sensing device receiving the sensing transmission, the sensing device receives a sensing response announcement.

Embodiment 5 is the system of any of embodiment 1 to embodiment 4, wherein the at least one processor is further configured to execute instructions to cause the at least one transmitting antenna to transmit the sensing measurement and the time stamp associated with the sensing measurement to a remote processing device.

Embodiment 6 is the system of any of embodiment 1 to embodiment 5, wherein the at least one processor is further configured to generate the time stamp by applying a propagation correction to a time determined according to the timing indication.

Embodiment 7 is the system of embodiment 6, wherein the propagation correction is indicative of a propagation time through a receive chain of the sensing device.

Embodiment 8 is the system of embodiment 6 or embodiment 7, wherein the at least one processor is further configured to apply the propagation correction such that the time stamp represents a reception time at which the timing indication of the sensing transmission used to perform a sensing measurement is received at a reference point of the sensing device.

Embodiment 9 is the system of any of embodiment 1 to embodiment 8, wherein the least one processor is further configured to execute instructions to apply an offset to a time determined according to the timing indication to generate the time stamp.

Embodiment 10 is a system comprising a remote processing device including at least one transmitting antenna, at least one receiving antenna, and at least one processor, wherein the at least one processor is configured to execute instructions to receive, via the at least one receiving antenna, a first sensing measurement and a first time stamp associated with the first sensing measurement from a first sensing device, receive, via the at least one receiving antenna, a second sensing measurement and a second time stamp associated with the second sensing measurement from a second sensing device, execute a sensing algorithm according to the first sensing measurement, the first time stamp, the second sensing measurement, and the second time stamp to generate a sensing result.

Embodiment 11 is the system of embodiment 10, wherein the at least one processor is further configured to execute instructions to transmit, via the at least one transmitting antenna, the sensing result to a third sensing device.

Each of the above described embodiments 1 through 11 of systems may further be implemented as methods carried out by appropriate systems and devices as described herein.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A system comprising:
a sensing initiator including at least one transmitting antenna, at least one receiving antenna, and at least one processor, wherein the at least one processor is configured to execute instructions to:
cause the at least one transmitting antenna to transmit a sensing trigger message;
receive, via the at least one receiving antenna, a sensing transmission transmitted in response to the sensing trigger message;
perform a sensing measurement on the sensing transmission;
generate a time stamp and associate the time stamp with the sensing measurement; and
generate an indication message, wherein the indication message includes the sensing measurement and the time stamp associated with the sensing measurement.

2. The system of claim 1, wherein the at least one processor is further configured to execute instructions to:
identify a timing indication in the sensing transmission, and
generate the time stamp to indicate when the sensing transmission was received based on the timing indication.

3. The system of claim 1, wherein the sensing measurement is performed using a training field of the sensing transmission.

4. The system of claim 1, wherein the at least one processor is further configured to execute instructions to cause the at least one transmitting antenna to transmit the indication message to a remote processing device.

5. The system of claim 2, wherein the at least one processor is further configured to generate the time stamp by applying a propagation correction to a time determined according to the timing indication.

6. The system of claim 5, wherein the sensing initiator is configured to function as a sensing receiver, and wherein the propagation correction is indicative of a propagation time through a receive chain of the sensing receiver.

7. The system of claim 5, wherein the at least one processor is further configured to apply the propagation correction such that the time stamp represents a reception time at which the timing indication of the sensing transmission used to perform a sensing measurement is received at a reference point of the sensing receiver.

8. The system of claim 2, wherein the at least one processor is further configured to execute instructions to apply an offset to a time determined according to the timing indication to generate the time stamp.

9. A method for Wi-Fi sensing, the method comprising:
transmitting, via at least one transmitting antenna of a sensing initiator, a sensing trigger message;
receiving, via at least one receiving antenna of the sensing initiator, a sensing transmission transmitted in response to the sensing trigger message;
performing, by at least one processor of the sensing initiator, a sensing measurement on the sensing transmission;
generating, by the at least one processor, a time stamp and associating the time stamp with the sensing measurement; and
generating, by the at least one processor, an indication message, wherein the indication message includes the sensing measurement and the time stamp associated with the sensing measurement.

10. The method of claim 9, further comprising:
identifying a timing indication in the sensing transmission, wherein
the time stamp indicates when the sensing transmission was received based on the timing indication.

11. The method of claim 9, wherein performing the sensing measurement uses a training field of the sensing transmission.

12. The method of claim 9, further comprising transmitting the indication message to a remote processing device.

13. The method of claim 10, wherein generating the time stamp includes applying a propagation correction to a time determined according to the timing indication.

14. The method of claim 13, wherein the sensing initiator is configured to function as a sensing receiver, and wherein the propagation correction is indicative of a propagation time through a receive chain of the sensing receiver.

15. The method of claim 13, wherein the method further comprises:
applying the propagation correction such that the time stamp represents a reception time at which the timing indication of the sensing transmission used to perform a sensing measurement is received at a reference point of the sensing receiver.

16. The method of claim 10, further comprising applying an offset to a time determined according to the timing indication to generate the time stamp.

17. A system comprising:
a sensing responder including at least one transmitting antenna, at least one receiving antenna, and at least one processor, wherein the at least one processor is configured to execute instructions to:
receive, via the at least one receiving antenna, a sensing trigger message;
generate, by the at least one processor, a sensing transmission responsive to the sensing trigger message, the sensing transmission including a timing indication, wherein the timing indication indicates timing of the sensing transmission;
transmit, via the at least one transmitting antenna, the sensing transmission.

18. The system of claim 17, wherein the timing indication indicates timing related to at least one of generation or transmission of the sensing transmission and is configured to permit generation of a time stamp by a sensing receiver.

19. A method for Wi-Fi sensing, the method comprising:
receiving, via at least one receiving antenna of a sensing responder, a sensing trigger message;
generating, by at least one processor of the sensing responder, a sensing transmission responsive to the sensing trigger message, the sensing transmission including a timing indication, wherein the timing indication indicates a time of transmission;
transmitting, via at least one transmitting antenna of the sensing responder, the sensing transmission including the timing indication.

20. The method of claim 19, wherein the timing indication indicates timing related to at least one of generation or transmission of the sensing transmission and is configured to permit generation of a time stamp by a sensing receiver.

21. The system of claim 2, wherein the timing indication is an identifiable pattern of bits within the sensing transmission.

22. The system of claim 2, wherein the timing indication is an identifiable bit within the sensing transmission.

23. The system of claim 22, wherein the timing indication is the first bit of a training field of the sensing transmission.

24. The system of claim 2, wherein the timing indication is an identifiable signal pattern within the sensing transmission.

25. The system of claim 2, wherein identifying the timing indication includes identifying a time at which the sensing transmission was received.

26. The system of claim 2, wherein identifying the time at which the sensing transmission was received includes identifying the time at which the sensing transmission was received at a reference point of the sensing initiator.

27. The method of claim 10, wherein the timing indication is an identifiable pattern of bits within the sensing transmission.

28. The method of claim 10, wherein the timing indication is an identifiable bit within the sensing transmission.

29. The method of claim 28, wherein the timing indication is the first bit of a training field of the sensing transmission.

30. The method of claim 10, wherein the timing indication is an identifiable signal pattern within the sensing transmission.

31. The method of claim 10, wherein identifying the timing indication includes identifying a time at which the sensing transmission was received.

32. The method of claim 31, wherein identifying the time at which the sensing transmission was received includes identifying the time at which the sensing transmission was received at a reference point of the sensing initiator.
